(19) United States
(12) Patent Application Publication
(10) Pub. No.: US 2014/0046699 A1
(43) Pub. Date: Feb. 13, 2014

(54) MEDICAL INFORMATION SYSTEM AND MEDICAL INFORMATION DISPLAY APPARATUS

(71) Applicants: Toshiba Medical Systems Corporation, Otawara-shi (JP); KABUSHIKI KAISHA TOSHIBA, Minato-ku (JP)

(72) Inventors: Hiroshi FUKATSU, Nagoya-shi (JP); Hisashi Kawai, Nagoya-shi (JP); Hikaru Futami, Nasushiobara-shi (JP); Kenichi Niwa, Otawara-shi (JP); Hiroki Saito, Otawara-shi (JP)

(73) Assignees: Toshiba Medical Systems Corporation, Otawara-shi (JP); KABUSHIKI KAISHA TOSHIBA, Minato-ku (JP)

(21) Appl. No.: 14/053,334

(22) Filed: Oct. 14, 2013

Related U.S. Application Data
(63) Continuation of application No. PCT/JP12/60298, filed on Apr. 16, 2012.

(30) Foreign Application Priority Data
Apr. 14, 2011 (JP) 2011-090240

(51) Int. Cl. G06F 19/00

(52) U.S. Cl. CPC G06F 19/322
USPC 705/3

(57) ABSTRACT

According to one embodiment, a medical information system includes a first storage unit, an extraction unit, a specifying unit, and a second storage unit. The first storage unit stores clinical statuses and character strings expressing the clinical statuses in association with each other. The extraction unit extracts a character string stored in the first storage unit from examination information concerning a target examination. The specifying unit specifies the clinical status associated with the extracted character string on the first storage unit. The second storage unit stores the examination identifier of the target examination and the specified clinical status in association with each other.

### CROSS-REFERENCE TO RELATED APPLICATIONS

This application is a Continuation Application of PCT Application No. PCT/JP2012/060298, filed Apr. 16, 2012 and based upon and claiming the benefit of priority from prior Japanese Patent Application No. 2011-90240, filed Apr. 14, 2011 the entire contents of which are incorporated herein by reference.

### FIELD

Embodiments described herein relate generally to a medical information system and a medical information display apparatus.

### BACKGROUND

Examination information such as patient examinations, examination images, and medical finding reports (ex. radiology or diagnostic reports about image-reading) are managed based on examination dates, patient IDs (patient identifiers), medical image acquiring apparatus types, and the like. Therefore, clinical statuses in examinations and the association between examinations are unknown.

When, for example, comparatively interpreting examination images before and after a medical treatment, the physician cannot know whether given examination images are those before and after a medical treatment, by simple automatic retrieval of images concerning the last examination and last but one examination based on a reference examination. In addition, the contents displayed on an examination list are generally given as the order of information managed (the order of examination dates, patient IDs, medical image acquiring apparatus types, or the like), and hence the association between examinations (for example, information indicating that examination A is a follow-up of examination B or indicating that examination C is not associated with examination A and examination B) is unknown. The physician therefore comprehends clinical statuses and the association between examinations by referring to electronic medical health records and the like or reading over past medical finding reports again.

It is an object to provide a medical information system and a medical information display apparatus which allow easy comprehension of the clinical statuses of examinations.

### BRIEF DESCRIPTION OF THE DRAWING

FIG. 1 is a block diagram showing the arrangement of a medical information system according to this embodiment.

FIG. 2 is a functional block diagram of the medical information system according to Example 1 of this embodiment.

FIG. 3 is a view showing an example of an initial table stored in an examination information storage unit in FIG. 2.

FIG. 4 is a view showing an example of a status/character string table held in a status/character string storage unit in FIG. 2.

FIG. 5 is a flowchart showing a typical procedure for information processing for examination information table generation performed by a control unit in FIG. 2.

FIG. 6 is a view for explaining processing in steps SA3 and SA4 in FIG. 5, showing an example of examination information concerning three examinations.

FIG. 7 is a view showing an example of an examination information table generated by an examination information table generation unit in step SA5 in FIG. 5.

FIG. 8 is a functional block diagram of a medical information system according to Example 2 of this embodiment.

FIG. 9 is a view showing an example of a disease name/character string table held in a disease name/character string storage unit in FIG. 8.

FIG. 10 is a view showing an example of an associated file written in the XML format which is stored in an associated file storage unit in FIG. 8.

FIG. 11 is a view showing an example of an associated file written in the RDB format which is stored in the associated file storage unit in FIG. 8.

FIG. 12 is a flowchart showing a typical procedure for information processing for examination information table generation performed under the control of a control unit in FIG. 8.

FIG. 13 is a view for explaining processing in step SB5 in FIG. 12, showing an example of examination information concerning three examinations.

FIG. 14 is a view showing an example of an examination information table according to Example 2 which is generated in step SB6 in FIG. 12.

FIG. 15 is a functional block diagram of a medical information system according to Example 3 of this embodiment.

FIG. 16 is a view showing an example of a layout table defining display positions by absolute positions, which is stored in a layout table storage unit in FIG. 15.

FIG. 17 is a view showing an example of a layout table defining display positions by relative positions, which is held in the layout table storage unit FIG. 15.

FIG. 18 is a view showing a display example of an examination map generated by an examination map generation unit in FIG. 15.

FIG. 19 is a view showing another display example of an examination map generated by the examination map generation unit in FIG. 15.

FIG. 20 is a view showing another display example of an examination map generated by the examination map generation unit FIG. 15.

FIG. 21 is a view showing a display example of examination icons on the examination map in FIG. 20.

FIG. 22 is a view showing an example of a display layout specified by a layout specifying unit in FIG. 15.

### DETAILED DESCRIPTION

In general, according to one embodiment, a medical information system includes a status storage unit, an extraction unit, a status specifying unit, an examination information storage unit. The status storage unit stores clinical statuses and character strings expressing the clinical statuses in association with each other. The extraction unit extracts a character string stored in the status storage unit from examination information concerning a target examination. The status specifying unit specifies a clinical status associated with the extracted character string on the status storage unit. The examination information storage unit stores an examination identifier of the target examination and the specified clinical status in association with each other.

A medical information system and a medical information display apparatus according to this embodiment will be described below with reference to the accompanying drawing.

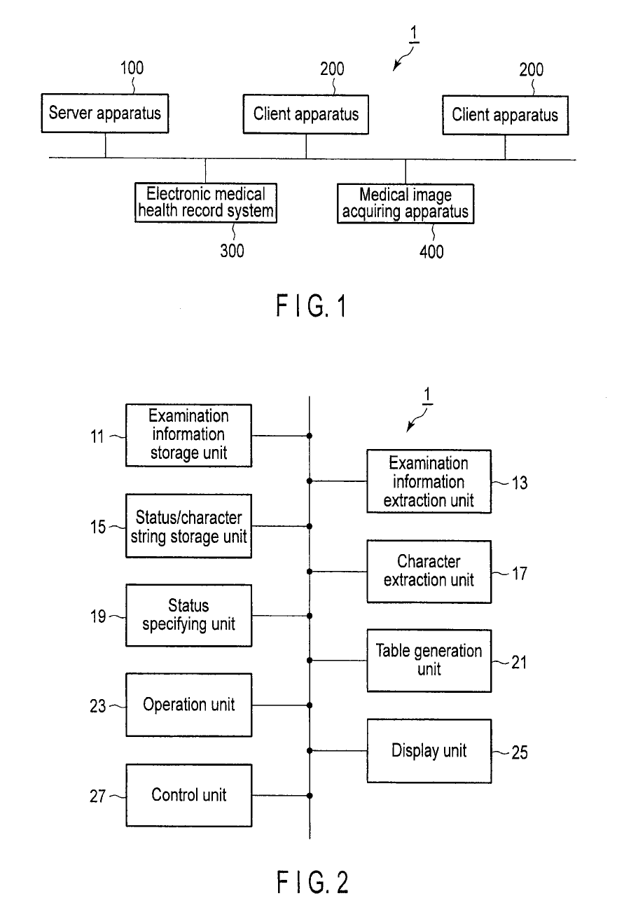

FIG. 1 shows the arrangement of a medical information system 1 according to this embodiment. As shown in FIG. 1, the medical information system 1 according to this embodiment includes a server apparatus 100, a client apparatus (medical information display apparatus) 200, an electronic medical health record system 300, and a medical image acquiring apparatus 400, which are connected to each other via a network. It is possible to use any existing standards for image communication between the respective apparatuses, such as the DICOM standard serving as a medical image standard. Note that as information communication, TCP/IP (transmission control protocol/internet protocol) communication as an industry standard is typically used. Information is transmitted and received via a network on a packet basis (the basic unit of information to be transferred).

The electronic medical health record system 300 transmits examination request information (a patient ID, examination date, examination name, examination region, examination comment, and the like) to the medical image acquiring apparatus 400 or the server apparatus 100. The medical image acquiring apparatus 400 acquires an examination image of the patient in accordance with the examination request information from the electronic medical health record system 300. The acquired examination image is transmitted to the server apparatus 100. It is possible to use, as the medical image acquiring apparatus 400, any type of medical image acquiring apparatus such as an X-ray diagnostic apparatus, X-ray computed tomography apparatus, magnetic resonance imaging apparatus, ultrasonic diagnostic apparatus, or nuclear medicine diagnostic apparatus, as needed. The client apparatus 200 is a computer terminal which displays and inputs various kinds of information. The information input to the client apparatus 200 is transmitted to the server apparatus 100. In addition, information from the server apparatus 100 is displayed on the client apparatus 200. The client apparatus 200 has a function of generating a medical finding report (medical finding report) concerning an examination image. The medical finding report is transmitted to the server apparatus 100. In general, client apparatuses 200 are connected to the medical information system 1. The server apparatus 100 archives examination request information from the electronic medical health record system 300, examination images from the medical image acquiring apparatus 400, and medical finding reports in association with each other.

### EXAMPLE 1

FIG. 2 is a functional block diagram of the medical information system 1 according to Example 1. As shown in FIG. 2, the medical information system 1 according to Example 1 includes an examination information storage unit 11, an examination information extraction unit 13, a status/character string storage unit 15, a character extraction unit 17, a status specifying unit 19, a table generation unit 21, an operation unit 23, a display unit 25, and a control unit 27.

The examination information storage unit 11 stores examination information. Examination information includes examination images, examination request information, and radiology reports. In addition, examination information may be medical finding reports concerning an endoscopy or ultrasound examination. Supplementary information such as a patient ID, examination date, examination ID, series ID, image ID, and report ID is associated with examination information. The examination information storage unit 11 stores a table (to be referred to as an initial table hereinafter) to facilitate the retrieval of examination information concerning an examination to be processed. An examination to be processed will be referred to as a target examination hereinafter.

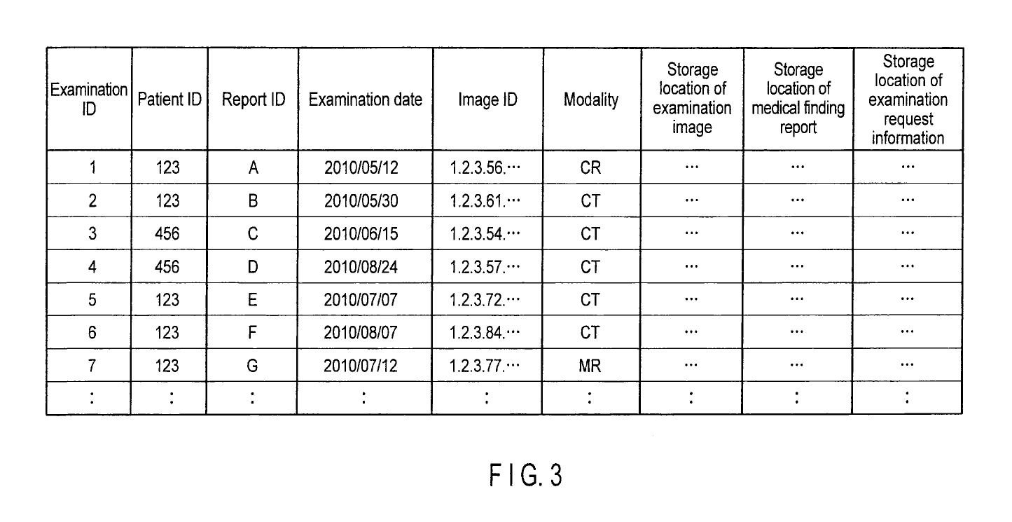

FIG. 3 shows an example of an initial table. As shown in FIG. 3, the initial table includes items such as examination ID, patient ID, report ID, examination date, image ID, and modality (medical image acquiring apparatus type). An examination ID is the identifier of an examination. A patient ID is the identifier of a patient. A report ID is the identifier of a medical finding report. An examination date is the date when an examination was executed. An image ID is the identifier of an examination image. A modality is the type of medical image acquiring apparatus used for an examination. The initial table also associates the storage location of an examination image, the storage location of a medical finding report, the storage location of examination request information, and the like with each examination ID.

The examination information extraction unit 13 extracts examination information concerning a target examination from the examination information storage unit 11 by using the initial table or an examination information table (to be described later).

The status/character string storage unit 15 stores clinical statuses and character strings expressing the clinical statuses in association with each other. Character strings expressing clinical statuses and the clinical statuses are associated with each other in a table (LUT: Look Up Table). This table will be referred to as a status/character string table hereinafter. The status/character string table is held in the status/character string storage unit 15.

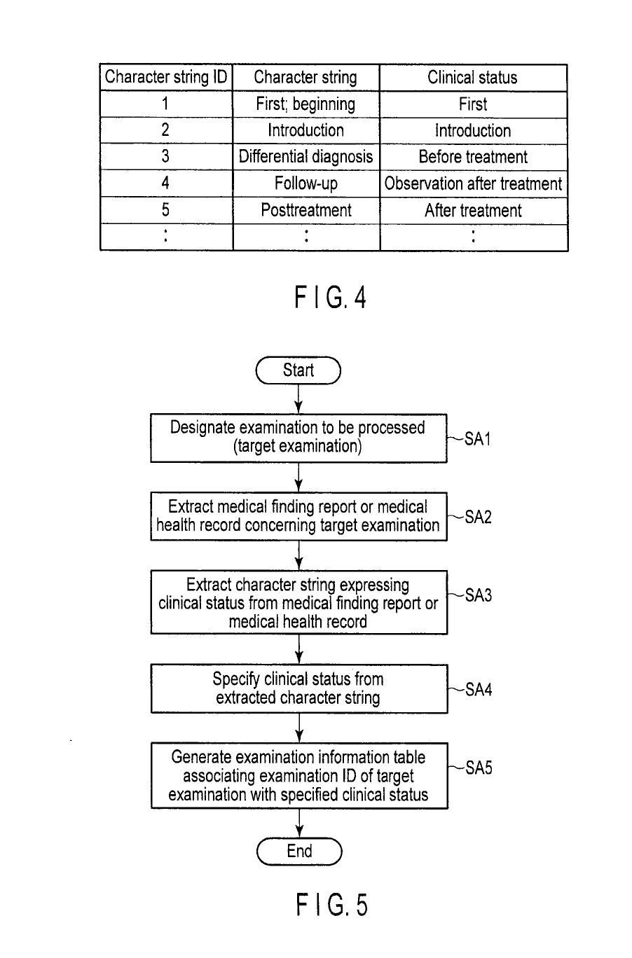

FIG. 4 shows an example of a status/character string table. As shown in FIG. 4, the status/character string table includes the following items: character string ID, character string, and clinical status. A clinical status indicates a clinical stage in an entire clinical process from the first to the end of a medical service. Clinical statuses include, for example, “first”, “introduction”, “before treatment”, “observation after treatment”, and “after treatment”. A character string is the one expressing a clinical status. A character string corresponding to the clinical status “first” includes, for example, “first” and “beginning”. A character string corresponding to the clinical status “introduction” includes, for example, “introduction”. A character string corresponding to the clinical status “before treatment” includes, for example, “differential diagnosis”. A character string corresponding to the clinical status “observation after treatment” is, for example, “follow-up”. A character string corresponding to the clinical status “after treatment” includes, for example, “after treatment”. A character string ID is the one assigned to a set of a character string and a clinical status which are associated with each other.

The character extraction unit 17 extracts a character string expressing a clinical status from examination information (a medical finding report or electronic medical health record). Character string candidates to be extracted are character strings registered in the character string item of the status/character string table. Note that portions from which character strings are to be extracted may include all entry fields in a medical finding report or electronic medical health record. That is, an extraction target includes not only a character string written in a status entry field in a medical finding report or electronic medical health record but also a character string freely written in a comment entry field by an operator.

The status specifying unit 19 specifies a clinical status associated with the character string extracted by the character extraction unit 17 on the status/character string table.

The table generation unit 21 generates an examination information table which associates the examination ID of a target examination with the clinical status specified by the status specifying unit 19. The generated examination information table is stored in, for example, the examination information storage unit 11. Note that the items of the examination information table are not limited to “examination ID” and “clinical status”. For example, the examination information table may include supplementary information items such as patient ID, examination date, examination ID, series ID, image ID, and report ID included in the initial table.

The operation unit 23 displays examination information such as an examination image, medical finding report, and electronic medical health record and the contents of an examination information table and initial table on a display device. It is possible to use, as a display device, for example, a CRT display, liquid crystal display, organic EL display, or plasma display, as needed.

The display unit 25 accepts various instructions from the user via an input device. For example, the user designates a target examination. It is possible to use, as an input device, a pointing device such as a mouse or trackball, a selecting device such as a mode switch, or an input device such as a keyboard, as needed.

The control unit 27 functions as the main unit of the medical information system 1. The control unit 27 stores, in a memory, an information processing program for examination information table generation. The control unit 27 reads out the information processing program upon receiving a start instruction via the operation unit 23, controls the respective units in accordance with the readout information processing program, and executes various kinds of processing for an examination information table generation.

For example, the examination information storage unit 11, the examination information extraction unit 13, the status/character string storage unit 15, the character extraction unit 17, the status specifying unit 19, the table generation unit 21, and the control unit 27 are implemented in the server apparatus 100. The operation unit 23 and the display unit 25 are implemented in the client apparatus 200. Note that the physical arrangement of the respective units in this embodiment is not limited to this. For example, the respective units implemented in the server apparatus 100 may be implemented in the electronic medical health record system 300 or the medical image acquiring apparatus 400. In addition, the client apparatus 200 (computer terminal) may incorporate the respective units implemented in the server apparatus 100 to operate as a standalone apparatus. If a heavy load is imposed on the computer terminal, the examination information extraction unit 13, the character extraction unit 17, the status specifying unit 19, and the like may be implemented in another apparatus to operate independently.

An example of the operation of the medical information system according to Example 1 will be described below. FIG. 5 shows a typical procedure for information processing for examination information table generation performed under the control of the control unit 27. As shown in FIG. 5, the control unit 27 stands by until a target examination is selected (step SA1). Typically, when a medical finding report is archived in the server apparatus 100, an examination to which the archived medical finding report belongs is designated as a target examination. Alternatively, the user may select a target examination via the operation unit 23. In this case, for example, the user designates a target examination from a list of examination information stored in the examination information storage unit 11 and displayed on the display unit 25 via the operation unit 23.

When a target examination is designated, the control unit 27 causes the examination information extraction unit 13 to perform examination information extraction processing (step SA2). In step SA2, the unit 13 extracts examination information concerning the target examination designated in step SAl from the examination information storage unit 11. The examination information extracted in step SA2 is examination information, of an examination image, medical finding report, and electronic medical health record, which includes a character string expressing a clinical status. Typically, a medical finding report and electronic medical health record are extracted in step SA2.

Upon execution of step SA2, the control unit 27 causes the character extraction unit 17 to perform character string extraction processing (step SA3). In step SA3, the unit 17 extracts a character string from the medical finding report and electronic medical health record extracted in step SA2. As described above, the extracted character string candidate is a character string registered in the status/character string table.

Upon execution of step SA3, the control unit 27 causes the status specifying unit 19 to perform specifying processing (step SA4). In step SA4, the status specifying unit 19 searches the status/character string table by using the character string extracted in step SA3 as a search key, and specifies the clinical status associated with the search key.

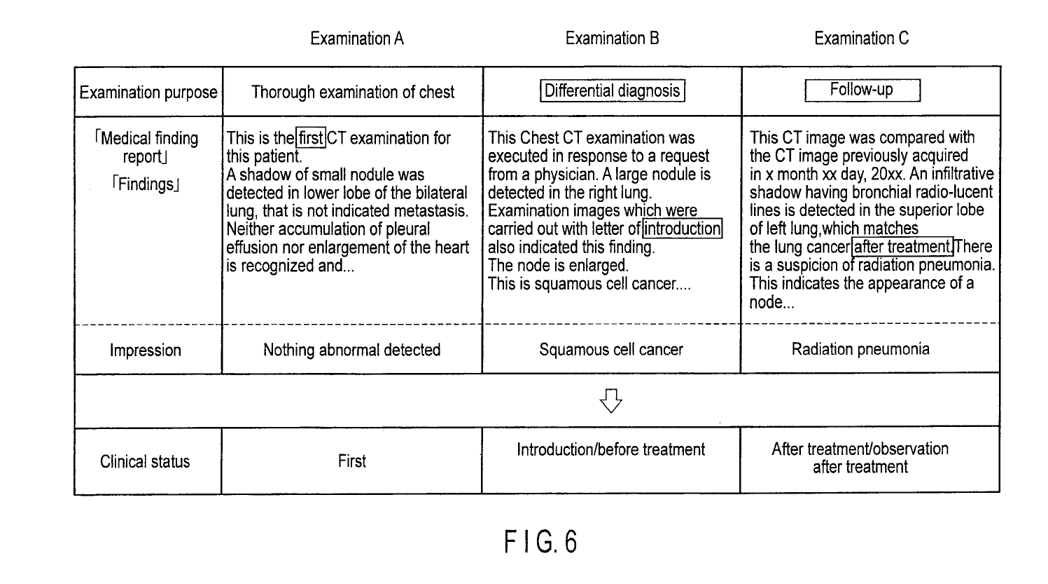

Processing in steps SA3 and SA4 will be described in detail below with reference to FIG. 6. FIG. 6 shows an example of examination information concerning three examinations. Note that “examination purpose” is an item provided in an electronic medical health record, and “Impression” is an item provided in a medical finding report. As shown in FIG. 6, the examination purpose concerning examination A does not include any character string for specifying a clinical status. The finding field of the medical finding report concerning examination A includes the description “. . . first CT examination for this patient”. The character string “first” in this field is registered in the status/character string table, as shown in FIG. 4. The character extraction unit 17 therefore extracts the character string “first” in “. . . first CT examination for this patient ” The status specifying unit 19 then specifies the clinical status “first” from the character string “first” by using the status/character string table.

Likewise, the examination purpose field concerning examination B includes the description “differential diagnosis”. This character string “differential diagnosis” is registered in the status/character string table, as shown in FIG. 4. The character extraction unit 17 therefore extracts the character string “differential diagnosis”. The status specifying unit 19 then specifies the clinical status “before treatment” from the character string “differential diagnosis” by using the status/character string table. In addition, the finding field of the medical finding report concerning examination B includes the description “introduction”. As shown in FIG. 4, this character string “introduction” is registered in the status/character string table. The character extraction unit 17 therefore extracts the character string “introduction”. The status specifying unit 19 then specifies the clinical status “introduction” from the character string “introduction” by using the status/character string table.

Likewise, in examination C, the character string “follow-up” is extracted from the examination purpose, and the character string “after treatment” is extracted from the finding field, thereby specifying the clinical status “observation after treatment” or “after treatment”.

In examination B or C, clinical statuses are specified for one examination in this manner. In this case, clinical statuses may be registered for one examination. In addition, it is possible to set priority levels for the respective clinical statuses to make the status specifying unit 19 limit one of clinical statuses in accordance with the priority levels. For example, the unit 19 may limit one of the clinical statuses which have the highest priority level.

In some case, the same clinical status may be specified concerning examinations on a given patient. Consider, for example, a case in which there are two examinations like examination A in FIG. 6 for patient A. In this case, the clinical status “first” is specified concerning each examination. The clinical status “first” indicates that patient A takes the examination for the first time. It is therefore undesirable to have two examinations concerning the clinical status “first”. In this case, the status specifying unit 19 may specify a clinical status in consideration of an examination date as well as the status/character string table. Assume that the examination date of examination A is older than that of examination B, and clinical statuses corresponding to examination A and examination B are both “first”. In this case, the unit 19 may set the clinical status of examination A to “first”, and the clinical status of examination B to a clinical status other than “first”. The unit 19 may be provided with a rule of setting the clinical status “first” for an examination with the oldest examination date. In this case, it is possible to omit character string extraction processing by the character extraction unit 17 concerning an examination with the oldest date.

Upon execution of step SA4, the control unit 27 causes the table generation unit 21 to perform generation processing (step SA5). In step SA5, the table generation unit 21 generates an examination information table associating the examination ID of the target examination designated in step SA1 with the clinical status specified in step SA4. The generated examination information table is held in the examination information storage unit 11. The unit 11 stores the examination ID of the target examination and its clinical status in association with each other in accordance with the examination information table. The display unit 25 may display the examination information table in accordance with an instruction from the user. In this case, the display unit 25 need not display all the records in the examination information table, and may display only the record matching the search condition designated by the user.

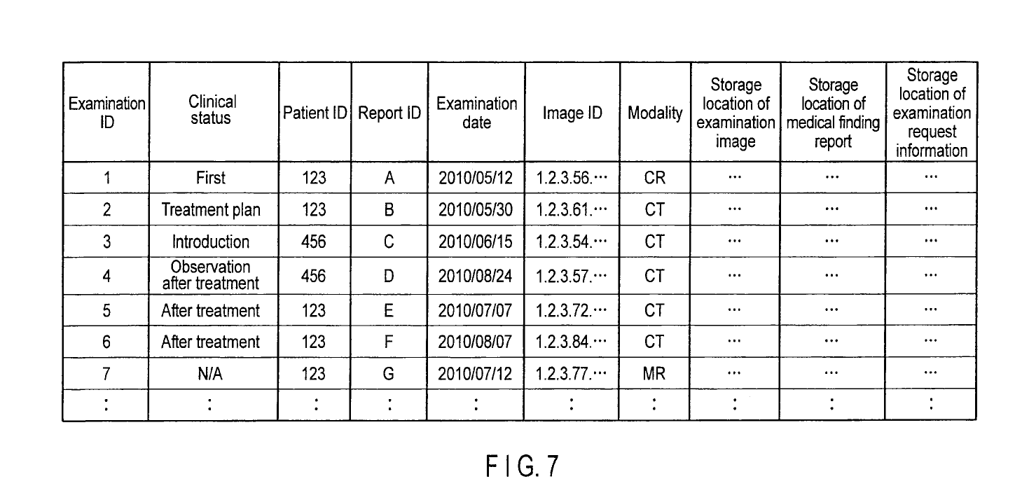

FIG. 7 shows an example of an examination information table. As shown in FIG. 7, the examination information table includes the following items: examination ID, clinical status, patient ID, report ID, examination date, image ID, and modality. As shown in FIG. 7, the examination information table associates examinations with clinical statuses. This allows the user to easily comprehend the clinical status of an examination by referring to the examination information table without referring back to any medical finding reports, electronic medical health records, or the like.

### EXAMPLE 2

A medical information system according to Example 2 specifies the medical association between examinations in accordance with a disease name or the like concerning each examination. The medical information system according to Example 2 will be described below. Note that the same reference numerals in the following description denote constituent elements having almost the same functions, and a repetitive description will be made only when required.

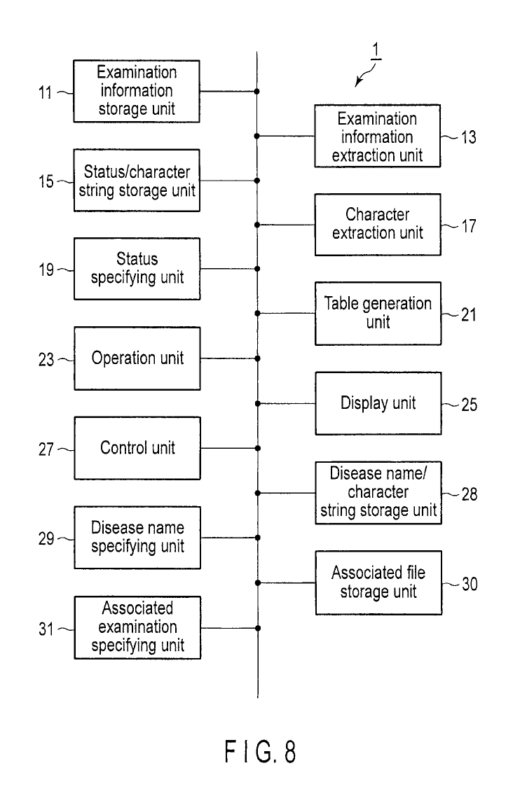

FIG. 8 is a functional block diagram of a medical information system 1 according to Example 2. As shown in FIG. 8, the medical information system 1 according to Example 2 includes a disease name/character string storage unit 28, a disease name specifying unit 29, an associated file storage unit 30, and an associated examination specifying unit 31 in addition to an examination information storage unit 11, an examination information extraction unit 13, a status/character string storage unit 15, a character extraction unit 17, a status specifying unit 19, a table generation unit 21, an operation unit 23, a display unit 25, and a control unit 27.

The disease name/character string storage unit 28 stores disease names and character strings expressing the respective disease names in association with each other. Character strings expressing disease names are associated with the disease names in a table. This table will be referred to as a disease name/character string table hereinafter, and a character string expressing each disease name will be referred to as a disease name character string hereinafter. The disease name/character string table is held in the disease name/character string storage unit 28.

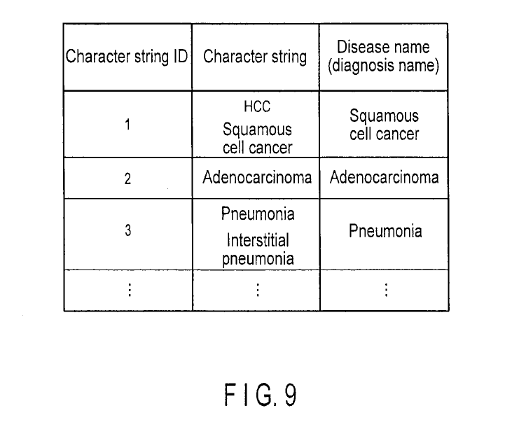

FIG. 9 shows an example of a disease name/character string table. As shown in FIG. 9, the disease name/character string table includes the following items: character string ID, character string, and disease name. A disease name is synonymous with a diagnosis name. Diagnosis names include, for example, squamous cell cancer, adenocarcinoma, and pneumonia. A character string is a disease name character string. A disease name character string corresponding to the disease name “squamous cell cancer” includes, for example, “HCC” and “squamous cell cancer”. A disease name character string corresponding to the clinical status “adenocarcinoma” includes, for example, “adenocarcinoma”. A disease name character string corresponding to the clinical status “pneumonia” includes, for example, “pneumonia” and “interstitial pneumonia”. A character string ID is an ID assigned to a set of a disease name character string and a disease name associated with each other.

The character extraction unit 17 according to Example 2 extracts a disease name character string from examination information such as a medical finding report or electronic medical health record. In Example 2, the pieces of examination information of examinations are set as extraction targets. In this case, an examination serving as a reference in specifying the association between examinations will be referred to as a target examination, and an examination whose association with a target examination is checked will be referred to as a comparative examination. The character extraction unit 17 extracts disease name character strings from examination information concerning a target examination and examination information concerning a comparative examination.

The disease name specifying unit 29 specifies a disease name associated with the disease name character string extracted by the character extraction unit 17 on the disease name/character string table. The table generation unit 21 associates the specified disease name with an examination ID and a clinical status in the examination information table. The examination information storage unit 11 stores examination IDs, clinical statuses, and disease names in association with each other.

The associated file storage unit 30 stores a file (to be referred to as an associated file hereinafter) ontologically describing the association between disease names. Various formats can be used as those of associated files. For example, it is possible to use the XML (extensible markup language) format or RDB (relational database) format.

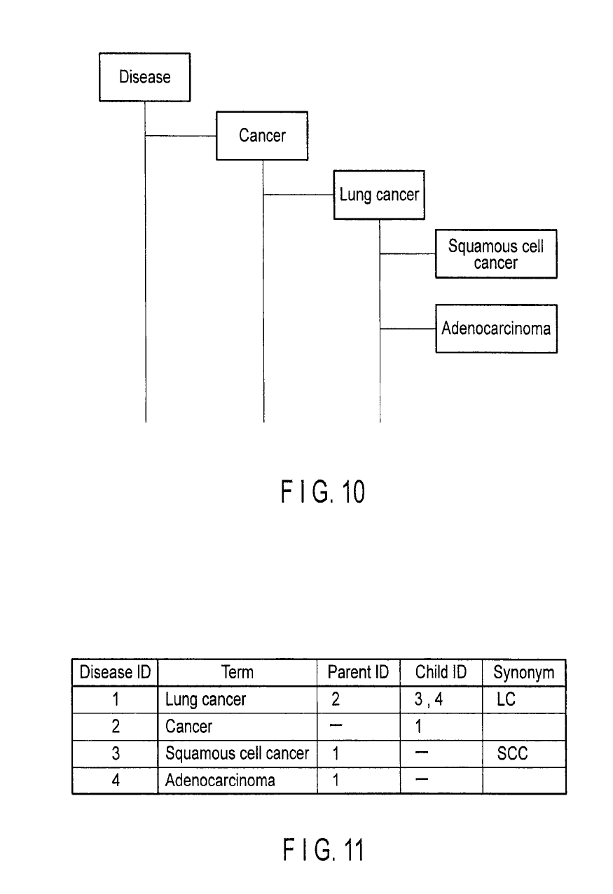

FIG. 10 is a schematic view showing an example of an associated file written in the XML format. As shown in FIG. 10, the associated file in the XML format describes disease names in a tree form in accordance with pathological classification. For example, the term “disease” is written on the uppermost layer. The term “cancer” is associated with the layer immediately below the term “disease”. The term “lung cancer” is associated with the layer immediately below the term “cancer”. The terms “squamous cell cancer” and “adenocarcinoma” are associated with the layer immediately below the term “lung cancer”.

FIG. 11 shows an example of an associated file written in the RDB format. As shown in FIG. 11, the associated file in the RDB format includes the following items: disease ID, term, parent ID, child ID, and synonym. A disease ID is the identification information of a disease. A term is a disease name character string. A parent ID is a patient disease ID of a disease which corresponds to the superordinate concept of the disease expressed by the term. A child ID is a child disease ID of a disease which corresponds to the subordinate concept of the disease expressed by the term. A synonym is a character string as another expression of a term. For example, “cancer” is a pathologically superordinate concept of the term “lung cancer”, and “squamous cell cancer” and “adenocarcinoma” are pathologically subordinate concepts of the term “lung cancer”. Therefore, “2” is registered as the parent ID of the term “lung cancer”, and “3” and “4” are registered as the child IDs.

The associated examination specifying unit 31 uses an associated file to determine, from a disease name character string concerning a target examination and a disease name character string concerning a comparative examination, whether the comparative examination is medically associated with the reference examination. An examination medically associated with a target examination will be referred to as an associated examination. In other words, the unit 31 has a function of specifying an associated examination medically associated with a reference examination.

When using an associated file in the XML format, the associated examination specifying unit 31 determines whether a disease concerning a reference examination and a disease concerning a comparative examination are located within a predetermined distance on the associated file. A predetermined distance is defined in accordance with the number of diseases appearing in the interval between a disease concerning a reference examination and a comparative examination on a tree chart in an associated file. The user can arbitrarily set a predetermined distance via the operation unit 23. If, for example, the predetermined distance is 2, a disease belonging to a layer two layers above or below a disease concerning a reference examination and a disease belonging to the same layer as that of the disease concerning the reference examination are associated with the disease concerning the reference examination. If a given disease is located within a predetermined distance, the associated examination specifying unit 31 determines that the corresponding comparative examination is an associated examination associated with the reference examination. If the disease is not located within the predetermined distance, the unit 31 determines that the comparative examination is not an associated examination.

When using an associated file in the RDB format, the associated examination specifying unit 31 searches for an associated file by using the disease ID of a disease concerning a reference examination as a search key, and specifies the examination ID of an associated examination associated on the associated file. The specified examination ID is the examination ID of the associated examination associated with the reference examination. If no examination ID is specified, the unit 31 determines that there is no associated examination associated with the reference examination. The unit 31 may determine, as associated examinations, not only an examination directly associated with a reference examination on an associated file but also an examination indirectly associated with the reference examination. A directly associated examination means an examination written on a record to which the reference examination belongs in the associated file. An indirectly associated examination means an examination associated with the reference examination via examinations in the associated file.

The table generation unit 21 further associates the examination ID of the target examination with the examination ID of the associated examination specified by the associated examination specifying unit 31. The examination information storage unit 11 stores this examination information table.

The control unit 27 stores, in the memory, an information processing program for the generation of an examination information table associating a reference examination with associated examinations. The control unit 27 receives a start instruction via the operation unit 23 and reads out an information processing program. The control unit 27 then controls the respective units in accordance with the readout information processing program, and executes various types of processing for this examination information table generation.

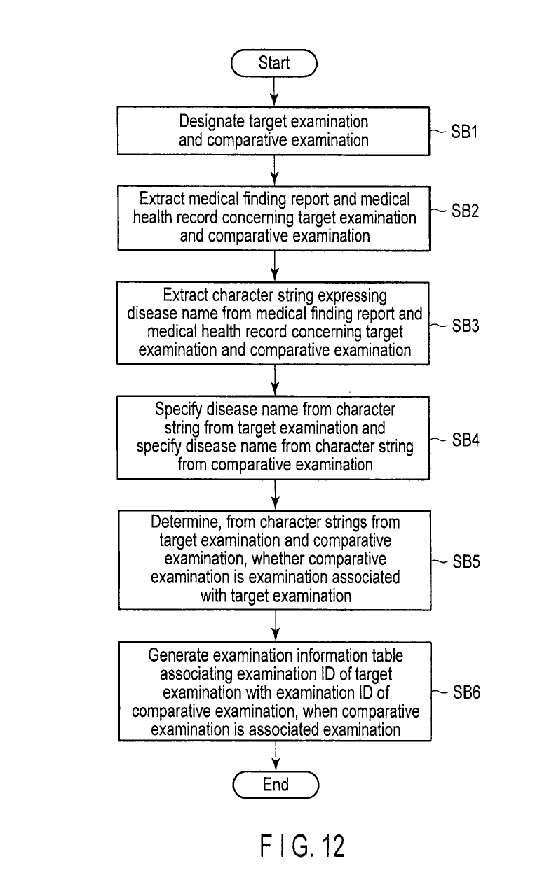

An example of the operation of the medical information system according to Example 2 will be described below. FIG. 12 shows a typical procedure for information processing for examination information table generation performed under the control of the control unit 27 according to Example 2.

As shown in FIG. 12, the control unit 27 stands by until a target examination and a comparative examination are selected (step SB1). Typically, when a medical finding report is archived in the server apparatus 100, an examination to which this archived medical finding report belongs is designated as a target examination. Alternatively, the user may select a target examination via the operation unit 23. The user designates a comparative examination from the list of examination information stored in the examination information storage unit 11 and displayed on the display unit 25 via the operation unit 23 or automatically. The number of comparative examinations to be selected is not limited to one but may be two or more. Note that the user may designate a target examination from the list of examination information stored in the examination information storage unit 11 and displayed on the display unit 25 via the operation unit 23.

When a target examination and a comparative examination are selected, the control unit 27 causes the examination information extraction unit 13 to perform examination information extraction processing (step SB2). In step SB2, the examination information extraction unit 13 extracts examination information concerning the target examination and comparative examination selected in step SB1. The examination information extracted in step SB2 is examination information, of an examination image, medical finding report, and electronic medical health record, which includes a character string expressing a disease name. Typically, a medical finding report and an electronic medical health record are extracted.

Upon execution of step SB2, the control unit 27 causes the character extraction unit 17 to perform character string extraction processing (step SB3). In step SB3, the unit 17 extracts a disease name character string from the medical finding report or electronic medical health record extracted in step SB2. As described above, an extracted character string candidate is a character string registered as a disease name in an associated file.

Upon execution of step SB3, the control unit 27 causes the disease name specifying unit 29 to perform disease name specifying processing (step SB4). In step SB4, the unit 29 specifies a disease name from the disease name character string of the target examination in step SB3 by using the disease name/character string table, and specifies a disease name from the disease name character string of the comparative examination in step SB3 by using the disease name/character string table.

The table generation unit 21 associates the disease name of the target examination with an examination ID and a clinical status in the examination information table. The examination information storage unit 11 stores the examination ID of the target examination, the clinical status, and the disease name in association with each other. The table generation unit 21 associates the disease name of the comparative examination with an examination ID and a clinical status in the examination information table. The examination information storage unit 11 stores the examination ID of the comparative examination, the clinical status, and the disease name in association with each other.

Upon execution of step SB4, the control unit 27 causes the associated examination specifying unit 31 to perform specifying processing (step SB5). In step SB5, the unit 31 uses the associated file to determine, from the disease name character string of the target examination and the disease name character string of the comparative examination, whether the comparative examination is an examination associated with the target examination.

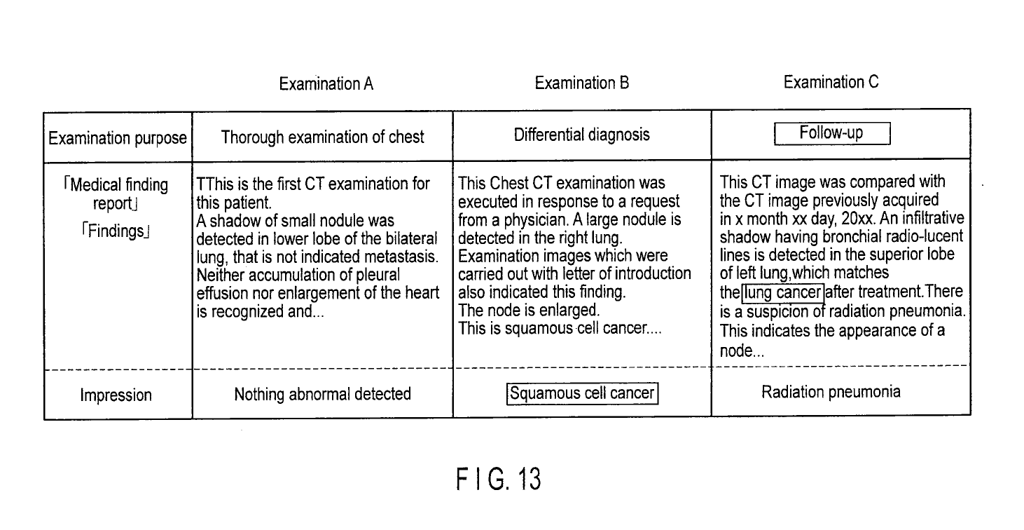

The processing in step SB5 will be specifically described below with reference to FIG. 13. FIG. 13 shows an example of examination information concerning three examinations. In the Impression field of the medical finding report concerning examination B, “squamous cell cancer” is written. In the finding field of the medical finding report concerning examination C, “lung cancer” is written. As shown in FIG. 13, these two terms are registered in the associated file. The character extraction unit 17 therefore extracts the term “squamous cell cancer” from the medical finding report concerning examination B, and the term “lung cancer” from the medical finding report concerning examination C. As indicated by the associated file shown in FIGS. 10 and 11, “squamous cell cancer” and “lung cancer” are pathologically associated with each other. More specifically, “squamous cell cancer” is included as a pathological concept in “lung cancer”. Assume that in this case, examination B is a target examination, and examination C is a comparative examination. In this case, the associated examination specifying unit 31 uses an associated file in the XML format or RDB format to determine that “squamous cell cancer” is associated with “lung cancer”, that is, examination C is an associated examination of examination B. If the unit 31 determines that the comparative examination is an associated examination of the reference examination, the process advances to step SB6. If the unit 31 determines that the comparative examination is not an associated examination of the reference examination, this system terminates the information processing without executing step SB6.

If the associated examination specifying unit 31 determines in step SB5 that the comparative examination is an associated examination, the control unit 27 causes the table generation unit 21 to perform generation processing (step SB6). In step SB6, the unit 21 associates the examination ID of the target examination with the examination ID of the associated examination in the examination information table. If the associated examination specifying unit 31 determines in step SB5 that the comparative examination is not the associated examination, no change is made in the examination information table. The display unit 25 may display the examination information table in accordance with an instruction from the user. In this case, the display unit 25 need not display all the records in the examination information table, and may display only the record matching the search condition designated by the user.

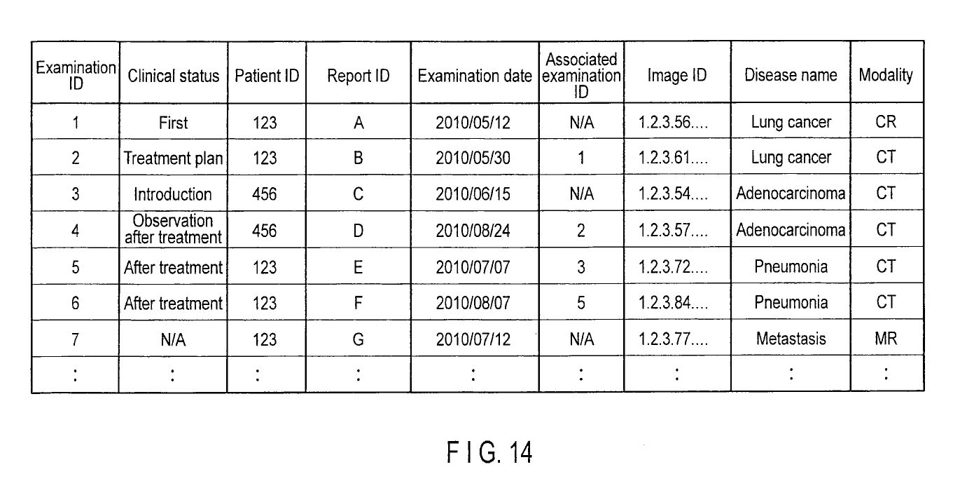

FIG. 14 shows an example of an examination information table according to Example 2. As shown in FIG. 14, the examination information table includes the items “associated examination ID” and “disease name” in addition to “examination ID”, “clinical status”, “patient ID”, “report ID”, “examination date”, “image ID”, and “modality”. An associated examination ID is the examination ID of an examination medically associated with the examination corresponding to the examination ID. “N/A” means empty (Null). A disease name is the name of an examined disease corresponding to an examination ID. As shown in FIG. 14, the examination information table associates examinations, clinical statuses, and associated examinations with each other. The user can therefore easily comprehend the association between examinations without referring back to any medical finding reports, electronic medical health records, or the like.

### EXAMPLE 3

A medical information system according to Example 3 displays examination information in a layout that allows the user to clearly comprehend clinical statuses and the association between examinations. The medical information system according to Example 3 will be described below. Note that the same reference numerals in the following description denote constituent elements having almost the same functions as those in Examples 1 and 2, and a repetitive description will be made only when required.

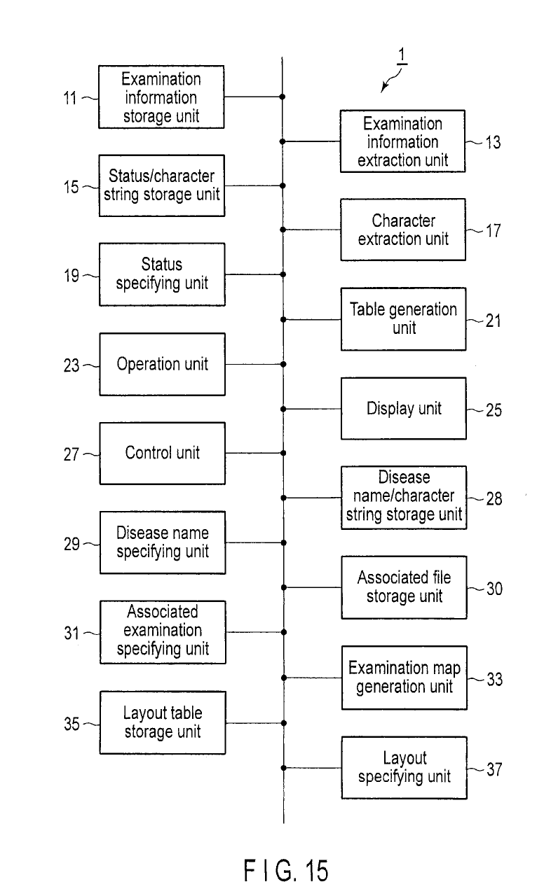

FIG. 15 is a functional block diagram of a medical information system 1 according to Example 3. As shown in FIG. 15, the medical information system 1 according to Example 3 includes an examination map generation unit 33, a layout table storage unit 35, and a layout specifying unit 37 in addition to an examination information storage unit 11, an examination information extraction unit 13, a status/character string storage unit 15, a character extraction unit 17, a status specifying unit 19, a table generation unit 21, an operation unit 23, a display unit 25, a control unit 27, a disease name/character string storage unit 28, a disease name specifying unit 29, an associated file storage unit 30, and an associated examination specifying unit 31.

The examination map generation unit 33 generates a map (to be referred to as an examination map hereinafter) on which the icons of examinations (to be referred to as examination icons hereinafter) are arranged in accordance with clinical statuses. As an examination icon, an image which allows to visually recognize the contents of an examination is used. For example, as an examination icon, it is possible to use a thumbnail of an examination image, a thumbnail of a medical finding report, a thumbnail of an electronic medical health record, character information of supplementary information (examination ID or the like), or the like. The display unit displays an examination map so as to allow to recognize the examination association between examinations as display targets. The display unit displays the examination association in the form of a line connecting examination icons or with a visual distinction so as to allow recognition.

The layout table storage unit 35 stores display layouts, clinical statuses, and display information types in association with each other. Typically, the unit 35 holds a table (to be referred to as a layout table hereinafter) associating clinical statuses and display information types with display layouts. A display layout means the display position of examination information of a display target. A display position is defined by an absolute position on a display window or a relative position from another piece of display information. Layout tables differ in accordance with differences in definition between display positions. Display information types include an examination image included in examination information, medical finding report, and electronic medical health record.

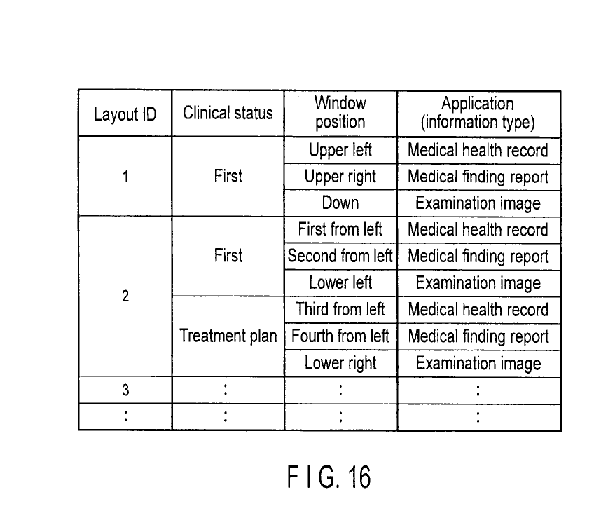

FIG. 16 shows an example of a layout table in which display positions are defined by absolute positions. As shown in FIG. 16, this layout table includes the following items: layout ID, clinical status, window position, and application (display information type). A clinical status is the clinical status of a target examination. Window positions are display positions on a display window, such as “upper left”, “upper right”, “down”, “first from left”, and “second from left”. An application is the type of examination information of a display target. The types of examination information of display targets include an examination image, medical finding report, and electronic medical health record. If, for example, layout ID is 2 and display information is an examination image, an examination image corresponding to the clinical status “first” is displayed at the lower left on a display window (or application window), and an examination image corresponding to the clinical status “treatment plan” is displayed at the upper right on the display window (or application window).

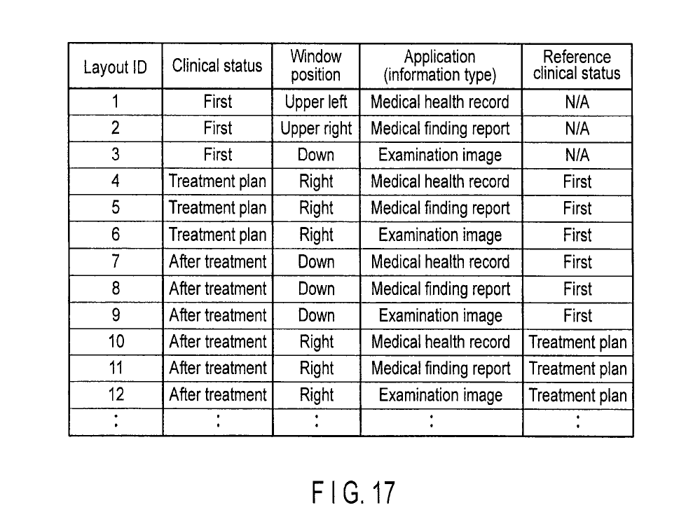

FIG. 17 shows an example of a layout table in which display positions are defined by relative positions. As shown in FIG. 17, this layout table includes the following items: layout ID, clinical status, window position, application (display information type), and reference clinical status. At the item “window position”, a relative position from the examination information of a reference examination, such as “upper left”, “upper right”, “down”, “right”, or “left”, is written. A reference examination is an examination displayed together with a target examination. At the item “reference clinical status”, the clinical status of a reference examination, such as “N/A”, “first”, or “treatment plan”, is written. If, for example, the layout ID is 5, a medical finding report corresponding to the clinical status “treatment plan” is displayed on the right of a medical finding report corresponding to the clinical status “first”.

The layout specifying unit 37 specifies the display layout of examination information by using the layout table. More specifically, when using a display layout which defines display positions by absolute positions, the unit 37 searches the layout table by using the clinical status of a target examination and a display information type as search keys, and specifies the display position associated with the search keys. When using a layout which defines display positions by relative positions, the unit 37 searches the layout table by using the clinical status of a target examination, a display information type, and the clinical status of a reference examination as search keys, and specifies the display position associated with the search keys.

The control unit 27 stores an information processing program for examination information display in the memory. The control unit 27 reads out the information processing program upon receiving a start instruction via the operation unit 23, and controls the respective units in accordance with the readout information processing program, thereby executing various types of processing for this examination information display.

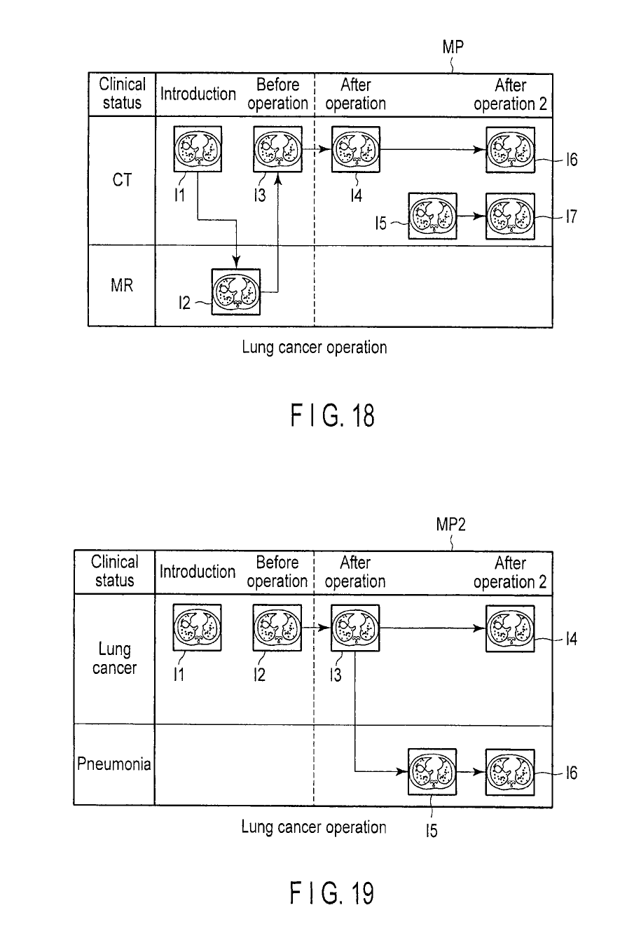

An example of the operation of the medical information system according to Example 3 will be described below. Examination map generation processing will be described first. FIG. 18 shows a display example of an examination map MP. As shown in FIG. 18, the examination map MP includes examination icons I (I1, I2, I3, I4, I5, I6, and I7) arranged in accordance with the clinical statuses. For example, the examination map MP is generated for one patient. A patient for which the examination map MP is to be generated is designated by the user via the operation unit 23. The examination map generation unit 33 generates a single examination map in accordance with examinations concerning the designated patient. Examinations for which an examination map is to be generated may be all the examinations concerning the designated patient or the examinations designated by the user via the operation unit 23.

First of all, the examination map generation unit 33 refers to the examination information table stored in the examination information storage unit 11 to specify the clinical status of each of target examinations. The examination map generation unit 33 then generates the examination map MP by arranging examination icons respectively corresponding to the examinations in the order of the clinical statuses.

The display unit 25 displays the examination map MP. In order to specify the examination association between examinations, the display unit 25 refers to the examination information table stored in the examination information storage unit 11. The display unit 25 recognizably displays the association between the examination icons of the target examinations and the examination icons of the associated examinations. More specifically, the display unit 25 connects examination icons respectively corresponding to examinations having examination association with arrows or the like in accordance with the examination association.

If, for example, the user issues, via the operation unit 23, a request to generate an examination map based on ID “4” and the associated examination in FIG. 14, the examinations corresponding to ID “2”, ID “1”, and ID “5” are specified as associated examinations. Examination icons respectively corresponding to examinations having examination association are connected with lines like arrows. An arrow head is directed to an examination icon of one of two examinations which is posterior in time.

For example, as shown in FIG. 18, the clinical status of an examination corresponding to the examination icon Ii is “introduction”, the clinical status of an examination corresponding to the examination icon I3 is “before operation”, the clinical status of an examination corresponding to the examination icon I4 is “after operation”, the clinical statuses of examinations corresponding to the examination icons I2 and I5 are “N/A”, and the clinical statuses of examinations corresponding to the examination icons I6 and I7 are “after operation”. If, for example, the examination corresponding to the examination icon I1 is associated with the examination corresponding to the examination icon I2, the examination icons I1 and I2 are connected with an arrow. If the examination corresponding to the examination icon I5 is not associated with the examination corresponding to the examination icon I6, the examination icons I5 and I6 are not connected with an arrow.

Note that in order to facilitate comprehension of examination association, the examination map generation unit 33 preferably arranges examination icons of associated examinations on the same row, while arranging the examination icons of examinations which are not associated with each other on different rows instead of arranging them on the same row.

In addition, the examination map generation unit 33 may arrange examination icons in consideration of not only clinical statuses but also other examination information such as medical image acquiring apparatus types (modality types). In this case, examination icons are arranged on the examination map MP according to modality types. For example, in the case shown in FIG. 18, the upper region of the examination map MP is set as a region for the examination icons of the examinations by a CT apparatus, and the lower region of the examination map MP is set as a region for the examination icon of the examination by an MR apparatus. This information to be considered is not limited to medical image processing apparatuses. For example, other examples are disease names and the like.

FIG. 19 shows a display example of an examination map MP2 generated in consideration of disease names. As shown in FIG. 19, the arrangement positions of the examination icons I1 to I6 of the examination map MP2 are sorted according to disease names. As disease names, it is possible to use all disease names such as lung cancer and pneumonia. For example, the examination icons I1 to I6 are sorted according to lung cancer and pneumonia. The examination icons I1 to I4 belong to the disease name “lung cancer”, and the examination icons I5 and I6 belong to the disease name “pneumonia”.

The examination map generation unit 33 may arrange information useful for the comprehension of an examination procedure on an examination map. For example, as shown in FIGS. 18 and 19, when the clinical statuses “before operation” and “after operation” are included, it is preferable to arrange an operation name such as “lung cancer operation” between the examination icon I3 of “before operation” and the examination icon I4 of “after operation”.

In this manner, examination icons are arranged on an examination map in accordance with the clinical statuses of examinations concerning a given patient and the association between the examinations. This allows the user to comprehend the clinical statuses of examinations and the association between them at a glance by only observing the examination map.

Note that the display form of the examination association between examinations is not limited to lines connecting the examination icons. As another method, the display unit 25 may display examination icons respectively corresponding to examinations having examination association while visually differentiating them from other examination icons.

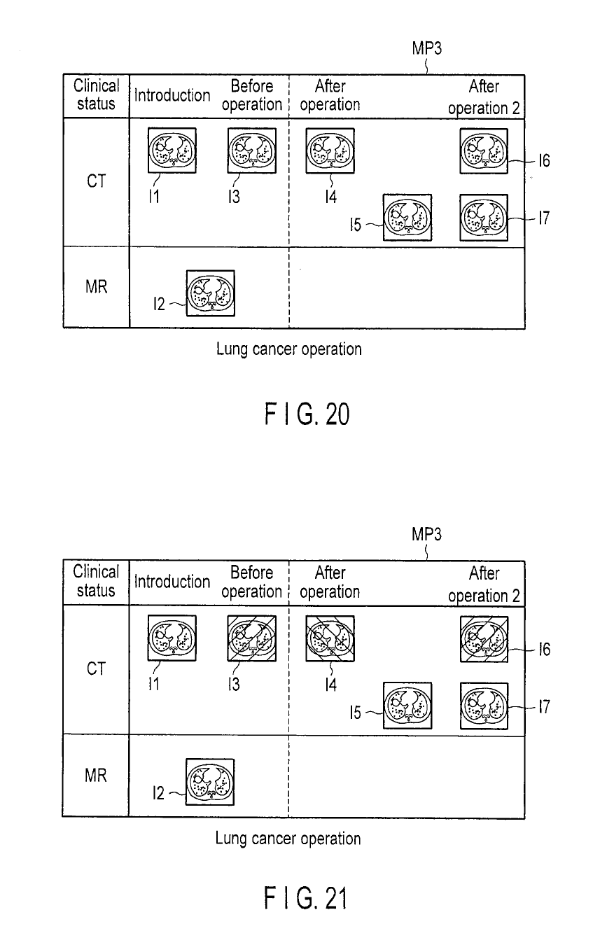

FIG. 20 is a view for explaining another method of displaying an examination map. As shown in FIG. 20, no arrow indicating examination association is displayed on an examination map MP3. The user designates an examination icon corresponding to an examination concerning which he/she wants to know an associated examination, among examination icons displayed on the examination map MP3, via the operation unit 23. Assume that the user has designated the examination icon I4. Assume that an examination corresponding to the examination icon I4 is associated with an examination corresponding to the examination icon I3 and an examination corresponding to the examination icon 16 as in the case shown in FIG. 18. When the user has designated the designated examination icon I4, the display unit 25 displays the examination icon I4, the examination icon I3, and the examination icon I6 in color different from other examination icons (that is, the examination icon I1, the examination icon I5, and the examination icon I7). In this manner, the display unit 25 displays examination icons having examination association while differentiating them from other examination icons. Note that the manner of differentiating examination icons is not limited to the means of using colors. For example, the display unit 25 may blink examination icons having examination association or frame the icons. Alternatively, the display unit 25 may mask other examination icons. In addition, the display unit 25 may display the designated examination icons I4 and I3 while visually differentiating them from the examination icons I3 and I6.

An example of the operation of the medical information system 1 in examination information display will be described next.

Assume that the display unit 25 is displaying an examination map. When the user selects an examination icon via the operation unit 23, the display unit 25 displays the examination information of an examination corresponding to the selected examination icon. In this case, it is preferable to also display the examination information of an examination associated with the examination corresponding to the selected examination icon. The layout specifying unit 37 specifies a display layout for the examination information. The user can arbitrarily designate the type of examination information to be displayed via the operation unit 23. In addition, the display unit 25 may display examination information corresponding to the type of examination icon. If, for example, a thumbnail of an examination image is set at an examination icon, the examination image is displayed. Likewise, when a thumbnail of a medical finding report is set at an examination icon, the medical finding report is displayed. When a thumbnail of an electronic medical health record is set at an examination icon, the electronic medical health record is displayed.

Assume that the user has designated one of the examination icons in FIG. 18, and the type of examination information to be displayed is an examination image. Assume also that the layout table defining the display positions by the absolute positions shown in FIG. 16 is used. In this case, the layout specifying unit 37 searches the display layout table by using the clinical status of the examination corresponding to the designated examination icon and the display information “examination image” as search keys, and specifies the display position associated with the search keys on the layout table. The display unit 25 displays an examination image of the examination corresponding to the designated examination icon at the specified display position. The layout specifying unit 37 also specifies an examination associated with the examination corresponding to the designated examination icon by using, for example, the examination information table. The layout specifying unit 37 searches the layout table by using the specified associated examination and the display information “examination image” as search keys, and specifies the display position associated with the search keys on the layout table. The display unit 25 displays the examination image of the associated examination at the specified display position.

An example of specifying a display layout by using the layout table defining display positions by relative positions shown in FIG. 17 will be described next. Assume that the user has designated one of the examination icons in FIG. 18, and the type of examination information as a display target is an examination image. In this case, the layout specifying unit 37 specifies an examination associated with the examination corresponding to the designated examination icon by using, for example, the examination information table. An examination corresponding to the designated examination icon is set as a target examination, and an associated examination is set as a reference examination. The layout specifying unit 37 searches the layout table by using the clinical status of the target examination, the clinical status of the reference examination, and the display information “examination image” as search keys, and specifies the display positions associated with the search keys on the layout table. The display unit 25 displays the examination image of the target examination and the examination image of the reference examination at the specified display positions. The display position of the first examination image may be specified by using the layout table in FIG. 16.

When the user has issued a request to generate an examination map, via the operation unit 23, based on the examination corresponding to ID 4 in FIG. 18 and its associated examination, the examinations corresponding to ID 2 and ID 1 are specified as examinations associated with the examination corresponding to ID 4, as shown in FIG. 14. The display unit 25 then displays, from the layout table in FIG. 16, the examination image corresponding to the clinical status “treatment plan” on the right side of the examination image corresponding to the clinical status “first”, and the examination image corresponding to the clinical status “after treatment” on the right side of the examination image corresponding to the clinical status “treatment plan”. That is, the examination image corresponding to the clinical status “first”, the examination image corresponding to the clinical status “treatment plan”, and the examination image corresponding to the clinical status “after treatment” are arranged in the order named from the left.

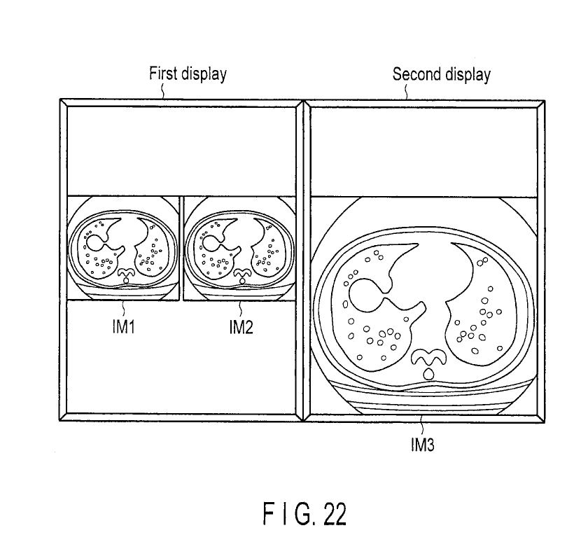

FIG. 22 shows an example of a display layout. As shown in FIG. 18, an examination image IM1 concerning the clinical status “first” is displayed on the left side on the first display, and an examination image IM2 concerning the clinical status “treatment plan” is displayed on the right side. In addition, on the second display, an examination image IM3 concerning the clinical status “after treatment” is displayed. In this manner, the display unit 25 can display pieces of examination information in the display layout specified by the layout specifying unit 37. The pieces of examination information displayed in this manner are limited to those associated with each other, and display layouts corresponding to clinical statuses are automatically selected. This allows the user to easily comprehend the clinical statuses of pieces of examination information and the association between them.

In the above example, designating an examination icon will set an examination as a display target. However, this embodiment is not limited to this. For example, the user may designate an examination as a display target on an initial table or an examination information table via the operation unit 23.

As described above, according to Example 1, the clinical statuses of examinations are automatically specified from the description of examination information, and a table associating examination IDs with the clinical statuses is generated. This makes it possible to manage examinations in accordance with clinical statuses. This allows the user to easily comprehend the clinical statuses of examinations without referring back to any medical finding report or electronic medical health record.

According to Example 2, this system automatically specifies the association between examinations from the description of examination information, and generates a table associating examination IDs with associated examinations IDs. According to Example 2, therefore, it is possible to manage examinations in accordance with clinical statuses and examination association. This allows the user to easily comprehend the clinical statuses of examinations and the association between them without referring back to any medical finding report or electronic medical health record.

According to Example 3, this system generates an examination map on which examination icons are arranged in accordance with clinical statuses. The system displays the examination map to allow the user to recognize the examination association between the examinations. When the user wants to know the clinical statuses of examinations and the association between them, he/she can easily comprehend the clinical statuses and the association by observing the examination map without referring back any medical finding report or electronic medical health record. In addition, when examination information is to be displayed, a display layout corresponding to clinical statuses is automatically specified. The pieces of examination information of examinations are displayed in this display layout. Examination information as a display target is limited to that of examinations associated with each other. In observation of examinations, such as comparative reading, it is possible to save the labor of selecting images.

As described above, according to this embodiment, it is possible to easily comprehend the clinical statuses of examinations and the association between them.

Some embodiments of the present invention have been described above. However, these embodiments are presented merely as examples and are not intended to restrict the scope of the invention. These novel embodiments can be carried out in various other forms, and various omissions, replacements, and alterations can be made without departing from the gist of the invention. The embodiments and their modifications are also included in the scope and the gist of the invention as well as in the invention described in the claims and their equivalents.

1. A medical information system comprising:
a status storage unit configured to store a plurality of clinical statuses and a plurality of character strings expressing the clinical statuses in association with each other;
an extraction unit configured to extract a character string stored in the status storage unit from examination information concerning a target examination;
a status specifying unit configured to specify a clinical status associated with the extracted character string on the status storage unit; and
an examination information storage unit configured to store an examination identifier of the target examination and the specified clinical status in association with each other.

2. The medical information system of claim 1, further comprising a disease name storage unit and a disease name specifying unit,
wherein the disease name storage unit stores a plurality of disease names and a plurality of character strings expressing the disease names in association with each other,
the extraction unit extracts a first disease name character string expressing a first disease name concerning the target examination from examination information concerning the target examination,
the disease name specifying unit specifies a disease name associated with the extracted first disease name character string on the disease name storage unit, and
the examination information storage unit stores the specified disease name while associating the disease name with the examination identifier of the target examination and the specified clinical status.

3. The medical information system of claim 2, further comprising a determination unit,
wherein the extraction unit extracts a second disease name character string expressing a second disease name concerning another examination from examination information concerning the other examination,
the determination unit determines, in accordance with the first disease name character string and the second disease name character string, whether the other examination is an associated examination medically associated with the target examination, and
the examination information storage unit further associates the examination identifier of the associated examination with the examination identifier of the target examination and the clinical status, when the determination unit determines that the other examination is the associated examination.

4. The medical information system of claim 3, further comprising an examination map generation unit configured to generate an examination map on which at least an icon of the target examination and an icon of the associated examination are arranged in accordance with clinical statuses.

5. The medical information system of claim 4, further comprising a display unit configured to display the generated examination map.

6. The medical information system of claim 5, wherein the display unit displays the generated examination map so as to allow to recognize examination association between the target examination and the associated examination.

7. The medical information system of claim 6, wherein the examination map includes a line connecting an icon of the target examination and an icon of the associated examination.

8. The medical information system of claim 6, wherein the examination map includes an icon of the target examination, an icon of the associated examination, and an icon of another examination, and
the display unit displays the icon of the target examination, the icon of the associated examination, and the icon of the other examination while visually differentiates the icon of the target examination, the icon of the associated examination, and the icon of the other examination.

9. The medical information system of claim 5, wherein the icon of the target examination and the icon of the associated examination are arranged on the examination map according to medical image acquiring apparatus types or disease names.

10. The medical information system of claim 1, further comprising:
a layout storage unit configured to store a plurality of display layouts and a plurality of combinations in association with each other, each of combinations including clinical statuses concerning a target examination and display information types concerning a target examination;
a layout specifying unit configured to specify a display layout associated with a combination of a clinical status concerning the target examination and examination information type concerning the target examination on the layout storage unit; and
a display unit configured to display examination information concerning the target examination in the specified display layout.

11. The medical information system of claim 10, wherein a display position of display information in the display layout is defined by one of an absolute position on a display application window and a relative position from another display information.

12. A medical information system comprising:
a storage unit configured to store a clinical status of each of a plurality of examinations and examination association based on disease names in association with each other;
a designation unit configured to designate a plurality of examinations as display targets from the examinations;
a generation unit configured to generate an examination map on which a plurality of examination icons concerning the designated plurality of examinations are arranged in accordance with clinical statuses; and
a display unit configured to display the generated examination map so as to allow to recognize examination association between the designated plurality of examinations.

13. The medical information system of claim 12, wherein the examination map includes a line connecting a plurality of examination icons respectively corresponding to a plurality of examinations, of the examination icons, which have the examination association, in accordance with the examination association.

14. The medical information system of claim 12, wherein the display unit displays a plurality of examination icons respectively corresponding to a plurality of examinations, of the examination icons, which have the examination association, while visually differentiating the examination icons from other examination icons.

15. A medical information display apparatus comprising:
a storage unit configured to store a clinical status of each of a plurality of examinations and examination association based on disease names in association with each other;
a designation unit configured to designate a plurality of examinations as display targets from the examinations;
a generation unit configured to generate an examination map on which a plurality of examination icons concerning the designated plurality of examinations are arranged in accordance with clinical statuses; and
a display unit configured to display the generated examination map so as to allow to recognize examination association between the designated plurality of examinations.
